(19) United States
(12) Patent Application Publication
(10) Pub. No.: US 2013/0199075 A1
(43) Pub. Date: Aug. 8, 2013

(54) ABOVE WATER WINGED DUCK DECOY BOBBER

(71) Applicants: MARK ZLATOS, Carleton, MI (US); Daniel Burkett, Monroe, MI (US)

(72) Inventors: MARK ZLATOS, Carleton, MI (US); Daniel Burkett, Monroe, MI (US)

(21) Appl. No.: 13/365,572

(22) Filed: Feb. 3, 2012

(51) Int. Cl. A01M 31/06

(52) U.S. Cl. 43/3

(57) ABSTRACT

A hunting decoy system, such as a winged duck, for example, comprises a center rigid support, a flotation part, a horizontal stabilizing part, and a decoy body. The flotation part may be attached to the center rigid support. The horizontal stabilizing part may be attached to the center rigid support and the flotation part. The decoy body may be mounted at the top of the center rigid support. The decoy body may be adapted to be displayed above a water line in waters that are greater than three feet deep.

### BACKGROUND OF THE INVENTION

The present invention generally relates to hunting decoys, and more specifically relates to a winged duck decoy that is suspended above the surface of water by means of a floating device.

Winged decoys are commonly used in shallow waters where they are fixed to a metal rod that is stuck in the muddy bottom. This type of winged decoy may only be used in knee to waist deep waters. When hunting water fowl in deeper waters, people may have one only option which is a standard floating decoy that is tight to the water and really has no movement. Movement is a key to luring birds for hunting.

Therefore, there is a need for a winged decoy that can provide the appearance of above water movement.

### SUMMARY OF THE INVENTION

In one aspect of the present invention, a hunting decoy system comprises a center rigid support; a flotation part attached to the center rigid support; a horizontal stabilizing part attached to the center rigid support and the flotation part; and a decoy body mounted at top of the center rigid support, wherein the decoy body is adapted to be displayed above a water line.

In another aspect of the present invention, a hunting decoy system comprises a center rigid support; a flotation part attached to the center rigid support; an anchor attached to the center rigid support; and a decoy body mounted at the top of the center rigid support, wherein the decoy body is adapted to be displayed above a water line, and wherein the flotation part is adapted to stay under the water line.

These and other features, aspects and advantages of the present invention will become better understood with reference to the following drawings, description and claims.

### BRIEF DESCRIPTION OF THE DRAWINGS

FIG. 1 is a perspective view of a duck decoy according to an exemplary embodiment of the present invention;

FIG. 2 is a front view of a duck decoy according to the exemplary embodiment of the present invention shown in FIG. 1; and

FIG. 3 is a side view of a duck decoy according to the exemplary embodiment of the present invention shown in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a winged duck decoy that may be suspended above the surface of water by means of a floating device and may greatly increase a duck hunter's chance of luring in ducks while hunting in deep waters.

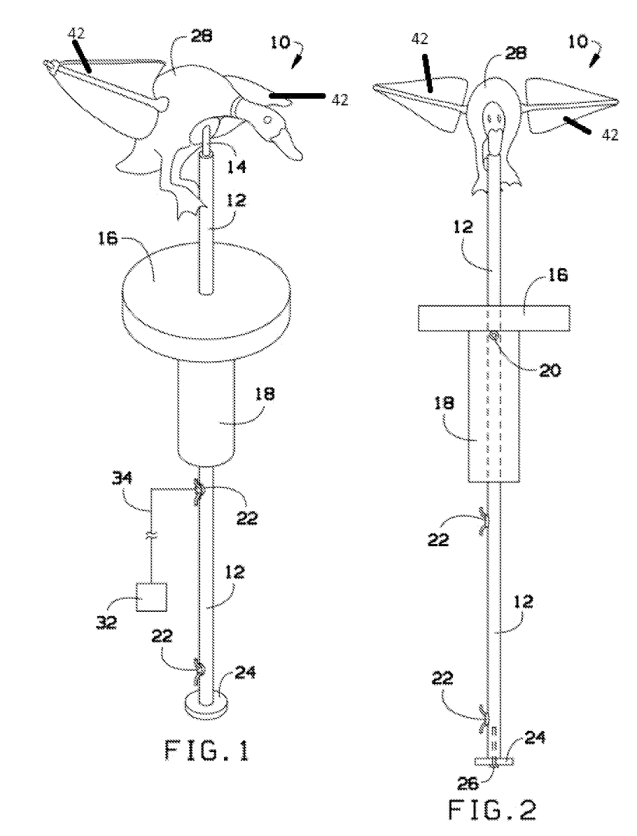

As shown in FIGS. 1-2, an exemplary embodiment of the present invention 10 may comprise a duck decoy 28 and a flotation part 18 as being able to bob within water, which suspends the duck decoy 28 above the water line. The flotation part 18 may comprise a block of plastics, such as Styrofoam™, for example, that is penetrated by a center rigid support 12; a horizontal stabilizing part 16, such as treated wood or wood-like platform; an anchor 32, an anchor line 34, and an anchor line tie 22, and a lead weight 24. The duck decoy 28 may have wings 42. A wooden mounting dowel 14 may extend from the breast of the duck decoy 28 to the center rigid support 12. The duck decoy 28 may be movable up and down with slidable wooden mounting dowel 14 when the horizontal stabilizing part 16 moves up and down.

The flotation part 18 may be assembled around a wooden center rigid support 12, which may be about 1 inch in diameter, for example, and may have a length suitable for three to four feet deep water, for example, into which the decoy may be placed.

A tube of the flotation part 18, such as Styrofoam™ may have a one-inch hole, for example, which has been drilled along the length and may be glued in place. A one-half inch center hole, for example, may be drilled in a piece of the horizontal stabilizing part 16, such as treated wood, for example. The horizontal stabilizing part 16 may have been Wolmanized® according to a process for pressure treating wood.

The horizontal stabilizing part 16 may have different shapes, such as a circle, square, or rectangle, for example, and may have a size of about 12 inches, for example, across a diameter or side. The treated wood part may be placed on the center rigid support 12 at the top of the tube of Styrofoam™ 18 and may also be glued in place.

A lead weight 24 may be attached by a screw 26, for example, to the end of the center rigid support 12. The lead weight 24 may be used as the base of the animal decoy. A one-half inch hole may be drilled vertically into the top end of the one inch mounting dowel 14 to attach the duck decoy 28.

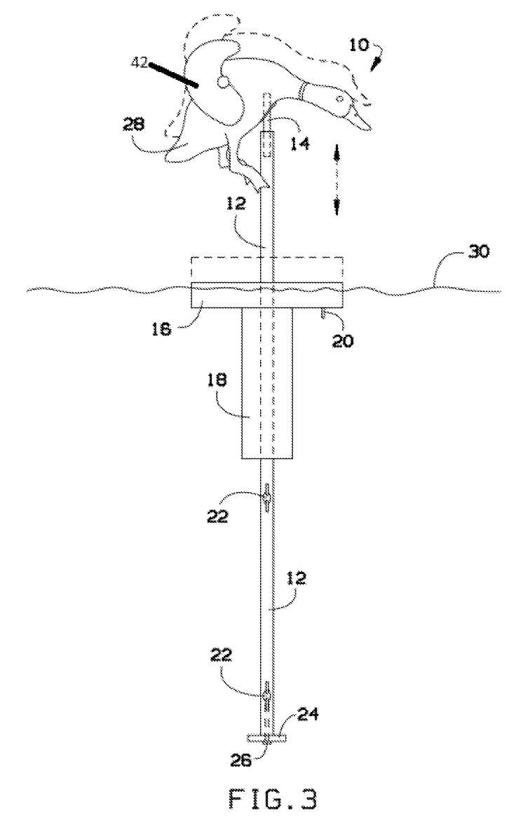

As shown in FIG. 3, the Styroform™ may make exemplary embodiments of the present invention 10 floatable. The horizontal stabilizing part 16, which may be treated wood platform, for example, together with the slidable wooden mounting dowel 14 and the raised center rigid support 12, may also help flotation and may be the main stabilizer for the device in the water.

Other parts of the device may comprise an anchor 32, which may be attached to the bottom portion of the one-inch mounting dowel 14 by an anchor line 34 and an anchor line tie 22 on the center rigid support 12. A decoy line (not shown) may also be attached to an eye screw 20 (also shown in FIG. 2) on the center rigid support 12 below the horizontal stabilizing part 16 to maintain control of the device. The decoy line and additional lead weights may be used to hold the device in place in the water so it does not float away.

The one-half inch mounting dowel 14 may be used to connect the duck decoy 28 to the center rigid support 12 by inserting it into the one-half inch hole drilled in the top of the center rigid support 12 and into a one-half hole, for example, in the breast region of the duck decoy 28. The distance between the duck decoy 28 and the horizontal stabilizing part 16 may be adjusted to place the duck decoy at various desired levels above the water line 30.

An exemplary embodiment of the present invention 10 may be painted in gray to camouflage it against the water. Various lengths of the center rigid support, the flotation part, the horizontal stabilizing part, different shapes and lengths of Styrofoam™, and anchor lines may be used to make the invention as long as these materials achieve the purpose of floating a duck decoy above the water line 30.

It should be understood, of course, that the foregoing relates to exemplary embodiments of the invention and that modifications may be made without departing from the spirit and scope of the invention as set forth in the following claims.

We claim:

1. A hunting decoy system, comprising:
a center rigid support;
a flotation part attached to the center rigid support;
a horizontal stabilizing part attached to the center rigid support and the flotation part; and,
a decoy body mounted at top of the center rigid support, wherein the decoy body is adapted to be displayed above a water line in waters, and wherein the flotation part is adapted to stay under the water line.

2. The hunting decoy system of claim 1 further comprising an anchor adapted to attach to the center rigid support.

3. The hunting decoy system of claim 1 further comprising a lead weight attached to the center rigid support.

4. The hunting decoy system of claim 1, wherein the animal decoy comprises a winged duck decoy.

5. The hunting decoy system of claim 1 further comprising a mounting dowel adapted to connect the animal decoy to the center rigid support.

6. The hunting decoy system of claim 5, wherein the mounting dowel is slidable along the center rigid support.

7. A hunting decoy system , comprising:
a center rigid support;
a flotation part attached to the center rigid support;
an anchor attached to the center rigid support; and
a decoy body mounted at the top of the center rigid support, and wherein the animal decoy is adapted to be displayed above a water line, and wherein the flotation part is adapted to stay under the water line.

8. The hunting decoy system of claim 7 further comprising a mounting dowel adapted to connect the animal decoy to the center rigid support.

9. The hunting decoy system of claim 8 wherein the mounting dowel is slidable along the center rigid support.

10. The hunting decoy system of claim 7 further comprising a horizontal stabilizing part attached to the center rigid support and the flotation part.
